(19) United States
(12) Patent Application Publication
(10) Pub. No.: US 2007/0095580 A1
(43) Pub. Date: May 3, 2007

(54) Power wheelchair with clutch control device

(75) Inventor: Feng-Huei Liao, Chia Yi City (TW)

Correspondence Address: OSTROLENK FABER GERB & SOFFEN, 1180 AVENUE OF THE AMERICAS, NEW YORK, NY, 100368403, US

(73) Assignee: Sunpex Technology Co., Ltd.

(21) Appl. No.: 11/259,775

(22) Filed: Oct. 27, 2005

(51) Int. Cl. B62D 11/02

(52) U.S. Cl. 180/6.5

(57) ABSTRACT

A power wheelchair includes a pair of clutches, each coupled to a respective drive power source and a respective drive wheel, and a clutch control device that includes a pair of rod pivoting units, a control unit, and a flexible linking unit interconnecting the control unit and the rod pivoting units. The rod pivoting units are coupled to rotary control rods of the clutches, respectively. By operating the control unit, drive power transmission of the clutches can be controlled accordingly.

### BACKGROUND OF THE INVENTION

1. Field of the Invention

The invention relates to a power wheelchair, more particularly to a power wheelchair equipped with a clutch control device for controlling drive power transmission of a pair of clutches.

2. Description of the Related Art

As shown in FIGS. 1 and 2, a conventional power wheelchair 1 includes a pair of clutches 11, each of which is mounted on a chair frame (not shown) and has a rotary control rod 111, a pair of motors 12 respectively coupled and supplying drive power to the clutches 11, a pair of drive wheels 13 respectively coupled to and driven by the clutches 11, and a clutch control device 14 for controlling drive power transmission of the clutches 11.

The clutch control device 14 includes a pair of rod pivoting components 141, each of which is coupled to the rotary control rod 111 of a respective one of the clutches 11, an intermediate connecting rod 142 having opposite ends connected pivotally and respectively to the rod pivoting components 141, a drive rod 143 connected pivotally to one of the rod pivoting components 141, a link 145 connected pivotally to the drive rod 143 and further connected to the chair frame so as to be pivotable about a pivot axis 144, and a handle 146 for controlling rotation of the link 145.

The handle 146 is operated when it is desired to enable or disable transmission of drive power by the clutches 11 from the motors 12 to the drive wheels 13, i.e., when it is desired to switch the power wheelchair 1 from a power driving mode to a manual driving mode, and vice versa. In particular, when the handle 146 is operated, the link 145 rotates about the pivot axis 144, and the drive rod 143 moves one of the rod pivoting components 141. The other rod pivoting component 141 also moves at this time due to the connection with the intermediate connecting rod 142.

The following are some of the drawbacks of the aforesaid conventional power wheelchair 1:

1. The intermediate connecting rod 142 of the clutch control device 14 is a rigid component that interconnects the rod pivoting components 141 and that requires some space for movement when switching the power wheelchair 1 between the power driving and manual driving modes, thereby resulting in restrictions to the spatial design (i.e., disposition of other components) of the conventional power wheelchair 1.

2. The intermediate connecting rod 142 and the drive rod 143, which are made of rigid metal material, result in a heavier total weight for the clutch control device 14.

### SUMMARY OF THE INVENTION

Therefore, the object of the present invention is to provide a power wheelchair with a clutch control device that can overcome the aforesaid drawbacks associated with the prior art.

Accordingly, a power wheelchair of the present invention comprises a chair frame, a pair of clutches, a pair of drive power sources, a pair of drive wheels, and a clutch control device.

The chair frame includes a pair of spaced apart lateral frame parts.

Each of the clutches is mounted on a respective one of the lateral frame parts of the chair frame, and includes a rotary control rod.

Each of the drive power sources is coupled and supplies drive power to a respective one of the clutches.

Each of the drive wheels is coupled to and is driven by a respective one of the clutches.

The clutch control device includes a pair of rod pivoting units, a control unit, and a flexible linking unit.

Each of the rod pivoting units has a rod coupling member and a restoring component. The rod coupling member is coupled to the rotary control rod of a respective one of the clutches, and is operable so as to rotate the rotary control rod of the respective one of the clutches between a first clutch position, in which the respective one of the clutches permits transmission of the drive power from the respective one of the drive power sources to the respective one of the drive wheels, and a second clutch position, in which the respective one of the clutches is inhibited from transmitting the drive power from the respective one of the drive power sources to the respective one of the drive wheels. The restoring component is coupled to the rod coupling member for accumulating a restoring force to restore the rotary control rod of the respective one of the clutches from the second clutch position to the first clutch position.

The control unit is mounted on the chair frame, and is operable between first and second control states.

The flexible linking unit interconnects the control unit and the rod coupling members of the rod pivoting units such that the rotary control rods of the clutches are disposed at the first clutch position when the control unit is at the first control state, and at the second clutch position when the control unit is at the second control state.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary perspective view of a conventional power wheelchair;

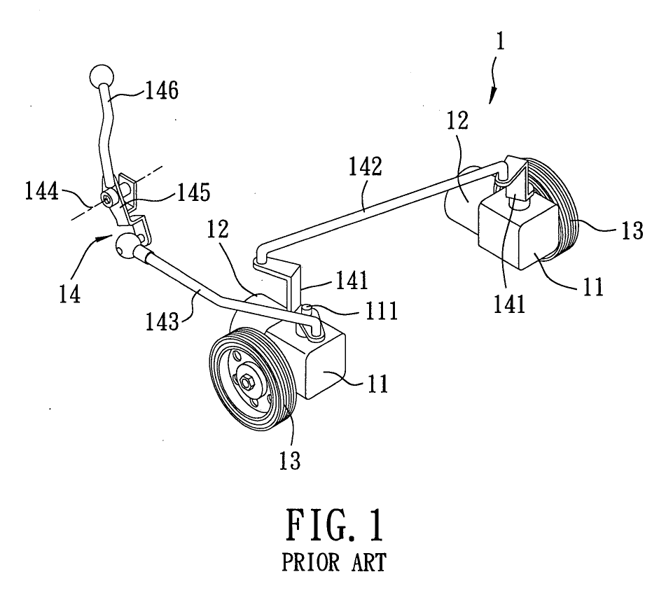

FIG. 2 is a schematic top view of FIG. 1;

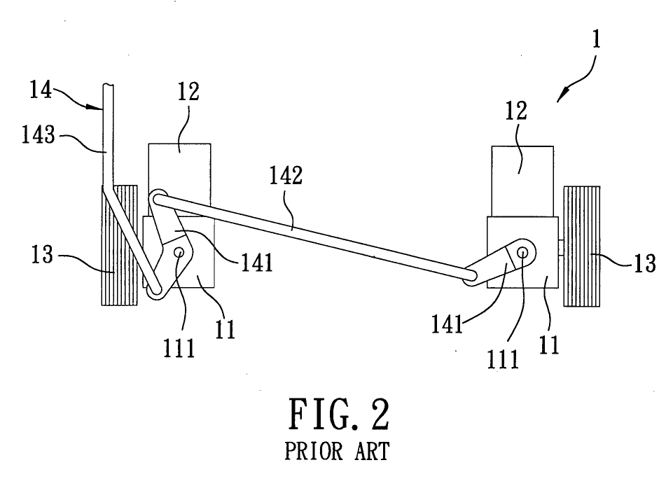

FIG. 3 is an assembled perspective view of the preferred embodiment of a power wheelchair according to the present invention;

FIG. 4 is a schematic top view of the preferred embodiment;

FIG. 5 is a fragmentary exploded perspective view to illustrate a rod pivoting unit of the preferred embodiment;

FIG. 6 is a fragmentary exploded perspective view to illustrate a control unit of the preferred embodiment;

FIG. 7 is a fragmentary schematic sectional view to illustrate a first control state of the control unit;

FIG. 8 is a fragmentary schematic top view to illustrate the rod pivoting unit when the control unit is at the first control state;

FIG. 9 is a fragmentary schematic sectional view to illustrate a second control state of the control unit; and

FIG. 10 is a fragmentary schematic top view to illustrate the rod pivoting unit when the control unit is at the second control state.

### DETAILED DESCRIPTION OF THE PREFERRED EMBODIMENT

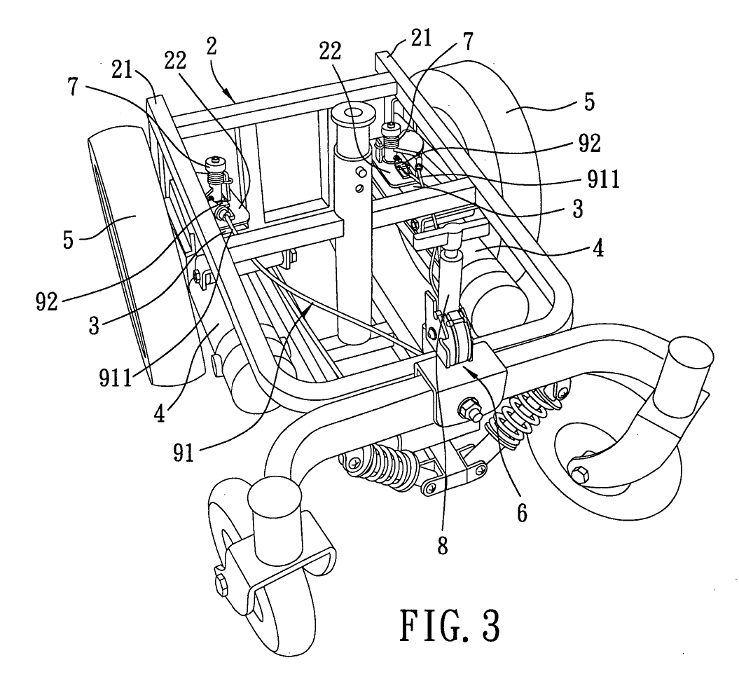

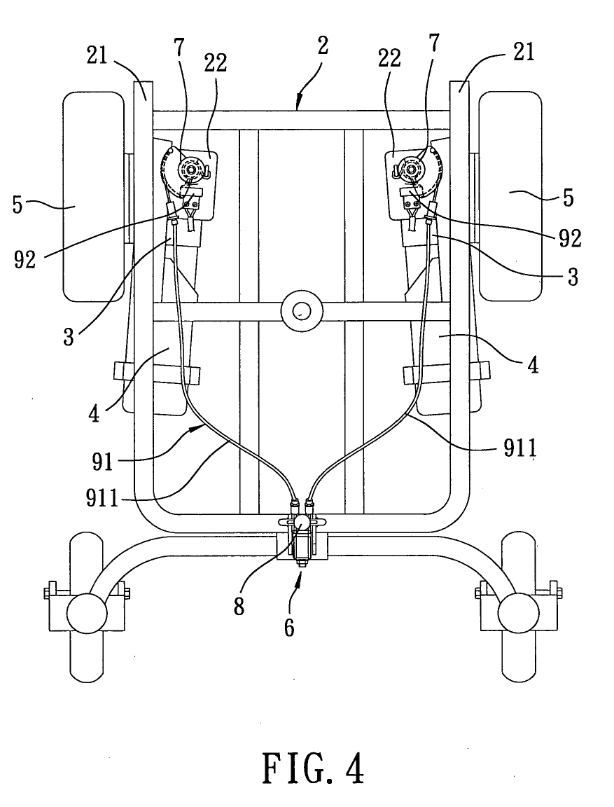

Referring to FIGS. 3 and 4, the preferred embodiment of a power wheelchair according to the present invention is shown to include a chair frame 2, a pair of clutches 3, a pair of drive power sources 4, a pair of drive wheels 5, and a clutch control device 6.

The chair frame 2 includes a pair of spaced apart lateral frame parts 21, each of which is provided with a respective mounting plate 22. Since the feature of the present invention does not reside in the specific configuration of the chair frame 2, further details of the same are omitted herein for the sake of brevity.

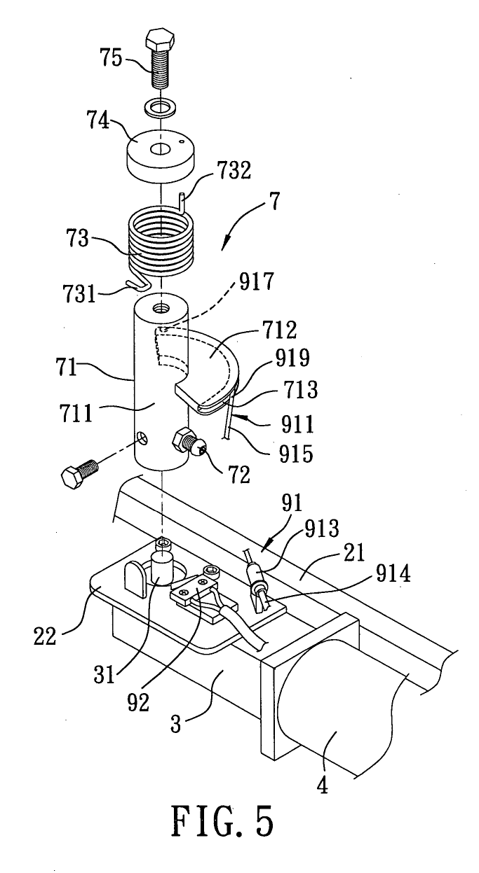

Each of the clutches 3 is mounted under the mounting plate 22 of a respective one of the lateral frame parts 21 of the chair frame 2, and includes a rotary control rod 31 that extends upwardly through the mounting plate 22, as best shown in FIG. 5. Since the clutches 3 are commercially available products, further details concerning the structure and operation thereof are dispensed with herein.

Each of the drive power sources 4 is coupled and supplies drive power to a respective one of the clutches 3. In this embodiment, each of the drive power sources 4 includes a motor.

Each of the drive wheels 5 is coupled to and driven by a respective one of the clutches 3.

The clutch control device 6 includes a pair of rod pivoting units 7, a control unit 8, a flexible linking unit 91, and a pair of contact switches 92.

With further reference to FIG. 5, each of the rod pivoting units 7 has a rod coupling member 71 and a restoring component 73. The rod coupling member 71 is coupled to the rotary control rod 31 of a respective one of the clutches 3, and is operable so as to rotate the rotary control rod 31 of the respective one of the clutches 3 between a first clutch position, in which the respective one of the clutches 3 permits transmission of the drive power from the respective one of the drive power sources 4 to the respective one of the drive wheels 5, and a second clutch position, in which the respective one of the clutches 3 is inhibited from transmitting the drive power from the respective one of the drive power sources 4 to the respective one of the drive wheels 5. The restoring component 73 is coupled to the rod coupling member 71 for accumulating a restoring force to restore the rotary control rod 31 of the respective one of the clutches 3 from the second clutch position to the first clutch position.

Each of the contact switches 92 is mounted on the mounting plate 22 of a respective one of the lateral frame parts 21, and is disposed adjacent to and is triggered by the rod coupling member 71 of a respective one of the rod pivoting units 7 to generate a disable signal for a corresponding one of the drive power sources 4 when the rotary control rod 31 coupled to the rod coupling member 71 is moved to the second clutch position.

In this embodiment, the rod coupling member 71 of each of the rod pivoting units 7 includes a sleeve part 711 that is disposed above the mounting plate 22 of a respective one of the lateral frame parts 21 and that is coupled co-rotatably to the rotary control rod 31 of the respective one of the clutches 3, a fan-shaped guide part 712 connected to and extending horizontally and outwardly from the sleeve part 711 and further connected to the flexible linking unit 91, and an actuator part 72 projecting outwardly from the sleeve part 711 and disposed to trigger the respective one of the contact switches 92 when the rotary control rod 31 coupled to the rod coupling member 71 is moved to the second clutch position. The guide part 712 is formed with a peripheral curved guide groove 713.

The restoring component 73 of each of the rod pivoting units 7 is in the form of a torsion spring in this embodiment, is sleeved on the sleeve part 711 of the rod coupling member 71, and has an anchoring end 731 anchored to the mounting plate 22 on a respective one of the lateral frame parts 21, and a restoring end 732 opposite to the anchoring end 731. Each of the rod pivoting units 7 further includes an end cap 74 coupled to the restoring end 732 of the restoring component 73, and a fastener 75 for fastening the end cap 74 to the sleeve part 711 of the rod coupling member 71 such that the restoring end 732 of the restoring component 73 is rotatable together with the end cap 74 and the rod coupling member 71 relative to the anchoring end 731.

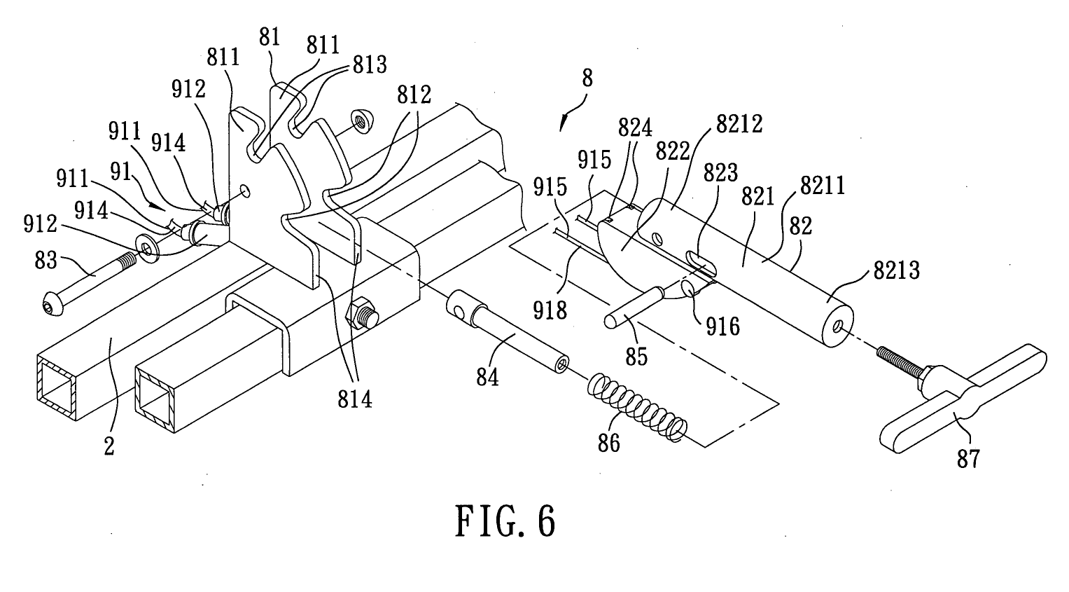

Referring to FIG. 6, the control unit 8 is mounted on the chair frame 2, and is operable between first and second control states. The control unit 8 includes a control base 81 mounted on the chair frame 2, a control lever 82 connected to the flexible linking unit 91, and a pivot axle 83 that mounts pivotally the control lever 82 to the control base 81 such that the control lever 82 is operable to dispose the control unit 8 at a selected one of the first and second control states (to be described in greater detail in the succeeding paragraphs).

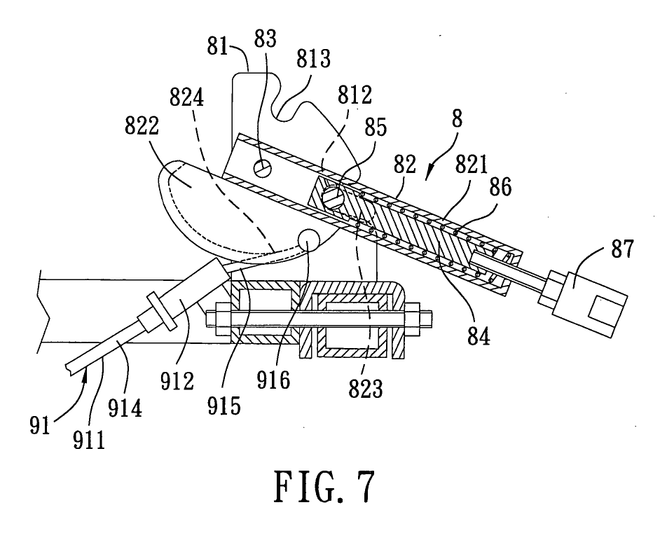

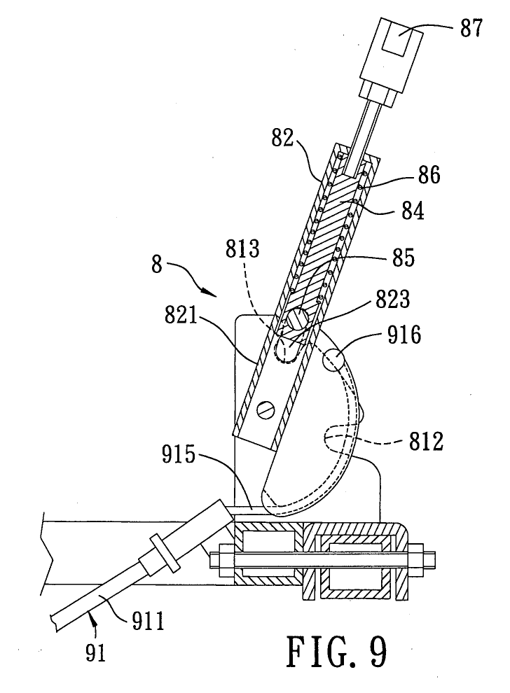

The control base 81 includes a pair of spaced apart pivot lugs 811 that are mounted fixedly on the chair frame 2. Each of the pivot lugs 811 has a curved lever engaging edge 814 formed with a pair of first and second engaging grooves 812, 813 that are angularly spaced apart from each other relative to the pivot axle 83. The first engaging grooves 812 of the pivot lugs 811 engage removably the control lever 82 when the control unit 8 is disposed at the first control state (see FIG. 7). The second engaging grooves 813 of the pivot lugs 811 engage removably the control lever 82 when the control unit 8 is disposed at the second control state (see FIG. 9).

The control lever 82 includes a tube body 821 that has a tube wall 8211 with opposite first and second tube ends 8212, 8213. The first tube end 8212 is mounted pivotally to the pivot lugs 811 by the pivot axle 83. The tube wall 8211 is formed with a guide slot unit 823 along a length thereof. The control lever 82 further includes a fan-shaped guide body 822 connected to the first tube end 8212 and further connected to the flexible linking unit 91, a pull rod 84 movably disposed in the tube body 821, a locking pin 85 extending through the pull rod 84 and the guide slot unit 823 and movable along the guide slot unit 823, a biasing member 86 for biasing the pull rod 84 toward the pivot axle 83 to enable the locking pin 85 to engage a selected pair of the first and second engaging grooves 812, 813 of the pivot lugs 811, and a handle 87 that is disposed outwardly of the tube body 821 and proximate to the second tube end 8213, that is connected to the pull rod 84, and that is operable so as to pull the pull rod 84 against biasing action of the biasing member 86 for disengaging the locking pin 85 from the first and second engaging grooves 812, 813. The guide body 822 preferably has a curved outer surface formed with a pair of spaced apart guide furrows 824. In this embodiment, the biasing member 86 is a compression spring that is disposed in the tube body 821.

The flexible linking unit 91 interconnects the control unit 8 and the rod coupling members 71 of the rod pivoting units 7 such that the rotary control rods 31 of the clutches 3 are disposed at the first clutch position when the control unit 8 is at the first control state, and at the second clutch position when the control unit 8 is at the second control state. The flexible linking unit 91 includes a pair of flexible components 911 (see FIGS. 3 and 4), each of which extends between the control unit 8 and the rod coupling member 71 of a respective one of the rod pivoting units 7. Each flexible component 911 includes a front connecting member 912 (see FIG. 6) mounted fixedly on the chair frame 2 adjacent to the guide body 822 of the control lever 82, a rear connecting member 913 (see FIG. 5) mounted fixedly on the mounting plate 22 of a respective one of the lateral frame parts 21 of the chair frame 2 adjacent to the guide part 712 of the rod coupling member 71 of the respective one of the rod pivoting units 7, a sheath 914 (see FIGS. 5 and 6) that interconnects the front and rear connecting members 912, 913, a flexible steel wire 915 (see FIGS. 5 and 6) movably extending through the sheath 914, a front end block 916 (see FIG. 6) fixed to the guide body 822 of the control lever 82 and connected to one end 918 of the steel wire 915, and a rear end block 917 (see FIG. 5) fixed to the guide part 712 of the rod coupling member 71 of the respective one of the rod pivoting units 7 and connected to the other end 919 of the steel wire 915. The end 918 of the steel wire 915 is guided by one of the guide furrows 824 in the guide body 822 of the control lever 82. The end 919 of the steel wire 915 is guided by the guide groove 713 in the guide part 712 of the rod coupling member 71 of the respective one of the rod pivoting units 7.

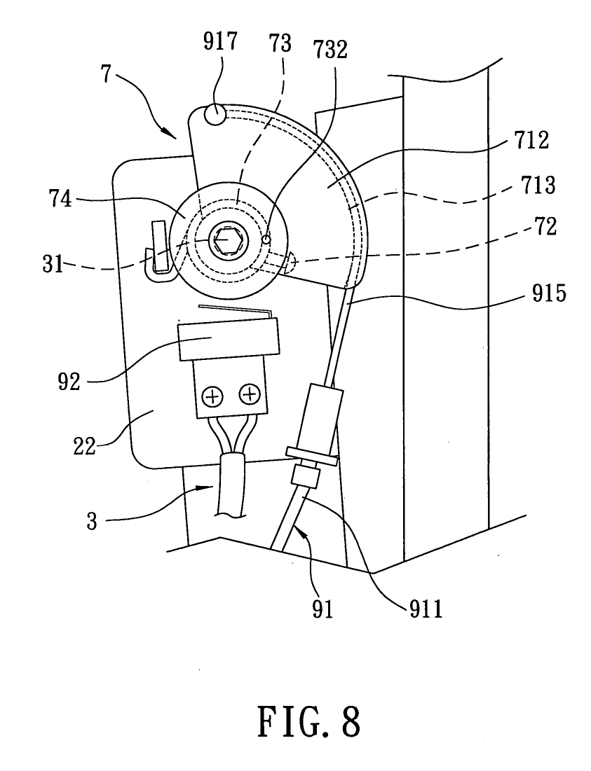

As shown in FIGS. 7 and 8, when the control unit 8 is at the first control state, the locking pin 85 of the control lever 82 engages the first engaging grooves 812 of the control base 81, and the restoring components 73 bias the rod coupling members 71 of the rod pivoting units 7 such that the rotary control rods 31 of the clutches 3 are disposed at the first clutch position. The actuator parts 72 of the rod coupling members 71 do not trigger the contact switches 92 at this time, thereby enabling power driving of the power wheelchair.

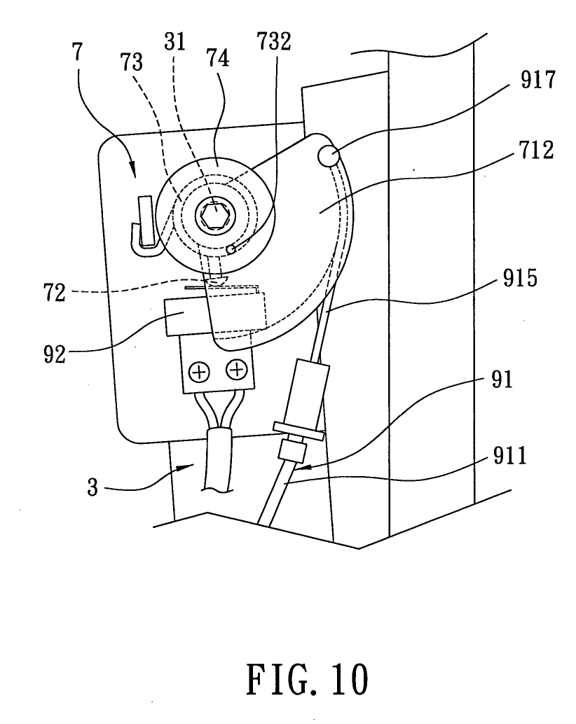

As shown in FIGS. 9 and 10, when the control unit 8 is operated to the second control state such that the locking pin 85 of the control lever 82 engages the second engaging grooves 813 of the control base 81, the steel wires 915 pull the rod coupling members 71 of the rod pivoting units 7 to rotate against the biasing action of the restoring components 73, thereby disposing the rotary control rods 31 of the clutches 3 at the second clutch position. At this time, the actuator parts 72 of the rod coupling members 71 trigger the contact switches 92 for disabling the drive power sources 4, thereby enabling manual driving of the power wheelchair.

Unlike the conventional power wheelchair, the clutch control device 6 utilizes the flexible linking unit 91 to interconnect the control unit 8 and the rod coupling members 71. As a result, spatial design of the power wheelchair of this invention has greater flexibility, and the total weight of the clutch control device 6 is reduced considerably.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A power wheelchair comprising:
a chair frame including a pair of spaced apart lateral frame parts;
a pair of clutches, each of which is mounted on a respective one of said lateral frame parts of said chair frame and includes a rotary control rod;
a pair of drive power sources, each of which is coupled and supplies drive power to a respective one of said clutches;
a pair of drive wheels, each of which is coupled to and driven by a respective one of said clutches; and
a clutch control device including
a pair of rod pivoting units, each of which has
a rod coupling member coupled to said rotary control rod of a respective one of said clutches, and operable so as to rotate said rotary control rod of the respective one of said clutches between a first clutch position, in which the respective one of said clutches permits transmission of the drive power from the respective one of said drive power sources to the respective one of said drive wheels, and a second clutch position, in which the respective one of said clutches is inhibited from transmitting the drive power from the respective one of said drive power sources to the respective one of said drive wheels, and
a restoring component coupled to said rod coupling member for accumulating a restoring force to restore said rotary control rod of the respective one of said clutches from the second clutch position to the first clutch position,
a control unit mounted on said chair frame and operable between first and second control states, and
a flexible linking unit interconnecting said control unit and said rod coupling members of said rod pivoting units such that said rotary control rods of said clutches are disposed at the first clutch position when said control unit is at the first control state, and at the second clutch position when said control unit is at the second control state.

2. The power wheelchair as claimed in claim 1, wherein said clutch control device further includes a pair of contact switches, each of which is disposed adjacent to and is triggered by said rod coupling member of a respective one of said rod pivoting units to generate a disable signal for a corresponding one of said drive power sources when said rotary control rod coupled to said rod coupling member is moved to the second clutch position.

3. The power wheelchair as claimed in claim 2, wherein said rod coupling member of each of said rod pivoting units includes a sleeve part coupled co-rotatably to said rotary control rod of the respective one of said clutches, a guide part connected to said sleeve part and further connected to said flexible linking unit, and an actuator part projecting outwardly from said sleeve part and disposed to trigger the respective one of said contact switches when said rotary control rod coupled to said rod coupling member is moved to the second clutch position.

4. The power wheelchair as claimed in claim 3, wherein each of said lateral frame parts of said chair frame is provided with a respective mounting plate, said clutches being respectively disposed under said mounting plates of said lateral frame parts, said rotary control rods of said clutches extending respectively and upwardly through said mounting plates of said lateral frame parts, said sleeve parts of said rod coupling members of said rod pivoting units being respectively disposed above said mounting plates of said lateral frame parts, said contact switches being mounted respectively on said mounting plates of said lateral frame parts.

5. The power wheelchair as claimed in claim 3, wherein said restoring component of each of said rod pivoting units is sleeved on said sleeve part of said rod coupling member, and has an anchoring end anchored to said mounting plate on a respective one of said lateral frame parts, and a restoring end opposite to said anchoring end,
each of said rod pivoting units further including an end cap coupled to said restoring end of said restoring component, and a fastener for fastening said end cap to said sleeve part of said rod coupling member such that said restoring end of said restoring component is rotatable together with said end cap and said rod coupling member relative to said anchoring end.

6. The power wheelchair as claimed in claim 1, wherein said flexible linking unit includes a pair of flexible components, each of which extends between said control unit and said rod coupling member of a respective one of said rod pivoting units.

7. The power wheelchair as claimed in claim 6, wherein said rod coupling member of each of said rod pivoting units includes a sleeve part coupled co-rotatably to said rotary control rod of the respective one of said clutches, and a guide part connected to said sleeve part and further connected to the respective one of said flexible components of said flexible linking unit, said guide part being formed with a curved guide groove for guiding the respective one of said flexible components.

8. The power wheelchair as claimed in claim 7, wherein each of said lateral frame parts of said chair frame is provided with a respective mounting plate, said clutches being respectively disposed under said mounting plates of said lateral frame parts, said rotary control rods of said clutches extending respectively and upwardly through said mounting plates of said lateral frame parts, said sleeve parts of said rod coupling members of said rod pivoting units being respectively disposed above said mounting plates of said lateral frame parts.

9. The power wheelchair as claimed in claim 7, wherein said restoring component of each of said rod pivoting units is sleeved on said sleeve part of said rod coupling member, and has an anchoring end anchored to said mounting plate on a respective one of said lateral frame parts, and a restoring end opposite to said anchoring end,
each of said rod pivoting units further including an end cap coupled to said restoring end of said restoring component, and a fastener for fastening said end cap to said sleeve part of said rod coupling member such that said restoring end of said restoring component is rotatable together with said end cap and said rod coupling member relative to said anchoring end.

10. The power wheelchair as claimed in claim 1, wherein said control unit of said clutch control device includes:
a control base mounted on said chair frame;
a control lever connected to said flexible linking unit; and
a pivot axle that mounts pivotally said control lever to said control base such that said control lever is operable to dispose said control unit at a selected one of the first and second control states.

11. The power wheelchair as claimed in claim 10, wherein said control base includes a pair of spaced apart pivot lugs, each of which has a lever engaging edge formed with a pair of first and second engaging grooves that are angularly spaced apart from each other relative to said pivot axle,
said first engaging grooves of said pivot lugs engaging removably said control lever when said control unit is disposed at the first control state,
said second engaging grooves of said pivot lugs engaging removably said control lever when said control unit is disposed at the second control state.

12. The power wheelchair as claimed in claim 11, wherein said control lever includes:
a tube body having a tube wall with opposite first and second tube ends, said first tube end being mounted pivotally to said pivot lugs by said pivot axle, said tube wall being formed with a guide slot unit along a length thereof;
a guide body connected to said first tube end and further connected to said flexible linking unit;
a pull rod movably disposed in said tube body;
a locking pin extending through said pull rod and said guide slot unit and movable along said guide slot unit;
a biasing member for biasing said pull rod toward said pivot axle to enable said locking pin to engage a selected pair of said first and second engaging grooves of said pivot lugs; and
a handle disposed outwardly of said tube body and proximate to said second tube end, connected to said pull rod, and operable so as to pull said pull rod against biasing action of said biasing member for disengaging said locking pin from said first and second engaging grooves.
